(19) United States
(12) Patent Application Publication
(10) Pub. No.: US 2011/0250355 A1
(43) Pub. Date: Oct. 13, 2011

(54) METHOD FOR PRODUCING A PATTERN ON A CONTINUOUS STRIP

(76) Inventors: Andrew Allum, Darwen Lancashire (GB); John Jeffrey, Blackburn (GB); David S. Ponton, Knusden (GB); Antony Morton, Ilkley (GB); Stephen Douglas, Blackburn Lancashire (GB)

(21) Appl. No.: 13/020,888

(22) Filed: Feb. 4, 2011

Related U.S. Application Data
(63) Continuation of application No. PCT/EP2009/059803, filed on Jul. 29, 2009.

(30) Foreign Application Priority Data
Aug. 4, 2008 (DE) 10 2008040973.1

(51) Int. Cl. B05D 5/00

(52) U.S. Cl. 427/256

(57) ABSTRACT

A method for producing a polymer topographic pattern on a continuous strip which has a longitudinal orientation and transverse orientation perpendicular thereto. The pattern is applied to an area of the continuous strip to be imprinted by means of an application device moving in relation to the strip in a basic movement which is parallel to the transverse orientation of the strip to produce the pattern. During production of the pattern, the position of the continuous strip parallel to its transverse orientation, relative to a stationary reference position, is measured and the position of the application device is changed by a correction movement parallel to the transverse orientation of the continuous strip when the position of the continuous strip parallel to its transverse orientation is changed, the correction movement being superimposed to the basic movement.

### CROSS REFERENCE TO RELATED APPLICATIONS

This is a continuation of PCT application No. PCT/EP2009/059803, entitled “METHOD FOR PRODUCING A PATTERN ON A CONTINUOUS STRIP”, filed Jul. 29, 2009, which is incorporated herein by reference.

### BACKGROUND OF THE INVENTION

1. Field of the Invention

The present invention relates to a method for producing a polymer topographic pattern on a continuous strip.

2. Description of the Related Art

Especially in the production of tissue paper, screens with decorative topographic patterns are used. Tissue paper thereby produced is embossed with the topographic pattern of the screens.

Various methods of applying the topographic pattern onto a continuous strip are known in the current state of the art. It is, for example, conceivable to apply the topographic pattern by means of a rotary screen printing process or extrusion die process.

Current paper machine clothing often has widths of 10 meters or more. In contrast, printing screens are usually 1 m to approximately 1.5 m wide. Therefore, printing screens used in rotary screen printing processes, as a rule, extend only over part of the width of the continuous strip, which is the reason why, with known clothing, the topographic pattern is formed, as a rule, of several path-type pattern segments, located adjacent to each other. The problem with this is that the adjacently located pattern segments are often considerably offset relative to each other. This offset of the pattern elements of the individual pattern segments detracts from the optical impression of the tissue paper produced on such paper machine clothing.

What is needed in the art is a method for producing a polymer topographic pattern on a continuous strip whereby the pattern elements of the pattern segments which are located adjacent to each other have almost no, or no offset at all, relative to each other.

### SUMMARY OF THE INVENTION

The present invention provides a method for producing a polymer topographic pattern on a continuous strip.

A continuous strip is provided which has a longitudinal orientation and a transverse orientation perpendicular thereto. In addition, an applicator device is provided by means of which the pattern is applied onto an area of the continuous strip which is to be imprinted. In order to produce the pattern, the applicator device moves in relation to the strip in a basic movement which is parallel to the transverse orientation of the strip. In addition, during production of the pattern:

i) The position of the continuous strip parallel to its transverse orientation, for example relative to a stationary reference position, is measured; and

ii) The position of the application device is changed by a corrective movement parallel to the transverse orientation of the continuous strip when the position of the continuous strip parallel to its transverse orientation is changed, the corrective movement being superimposed on the basic movement.

The position of the applicator device is corrected accordingly with each offset or drift of the continuous strip parallel to its transverse orientation. Due to this, a drift of the continuous strip is no longer recognizable in the pattern which is applied onto the continuous strip, since the position of the applicator device is corrected immediately and, accordingly, following measurement of the drift or offset parallel to the transverse orientation of the continuous strip. This permits clear improvement of the control over the polymer application parallel to the transverse orientation of the continuous strip, resulting in a clear reduction in the offset of pattern elements in the transverse direction of the continuous strip.

It is conceivable that the continuous strip is made continuous by means of a pintle seam. The continuous strip may be produced flat or continuous. It is conceivable that the continuous strip is a flat or continuous woven structure. If the continuous strip is woven flat, for example, then it may be made continuous, for example, by a woven seam connection.

The continuous strip with the topographic pattern finds application, for example, in the form of paper machine clothing, such as in the production of tissue paper. The continuous strip printed with the topographic pattern can be utilized as DSP screen or TAD screen. The topographic pattern may represent a decorative pattern.

In the production of the pattern, it is conceivable that during the basic movement, the applicator unit moves at times continuously and/or incrementally parallel to the transverse orientation of the continuous strip. In a continuous movement therefore, the basic movement is steady. In an incremental movement the basic movement occurs in discrete increments.

In this context, it is conceivable that the basic movement is directed from one to the other longitudinal edge of the continuous strip during the entire duration of pattern application. It is further conceivable that the basic movement during the pattern application in chronological sequence is directed first from one to the other longitudinal edge of the continuous strip, and then from the other to the one longitudinal edge of the continuous strip. A reciprocating motion of this type can of course be repeated.

In the first case, the applicator device moves in a basic movement parallel to the transverse orientation of the continuous strip in a direction either from left to right or from right to left. In the latter case, the applicator device moves in the basic movement parallel to the transverse orientation of the continuous strip in chronological sequence once or several times from left to right and back, or vice versa.

The response time between measurement of a change in position of the continuous strip and corrective movement is, for example, less than 100 ms, or less than 50 ms.

A further development of the present invention provides that the position of the continuous strip is measured several times in chronological sequence during the production of the pattern. In this context it is conceivable that the position of the continuous strip is measured at least every 5 to 50 ms, for example, at least every 10 to 30 ms.

During production of the pattern, the area of the continuous strip which is to be printed may move in a transport direction parallel to the longitudinal orientation of the continuous strip relative to the applicator device. This may be achieved by running the continuous strip during the transport movement around at least two rolls which are located at a distance from each other and positioned parallel to each other.

For this purpose the rolls and the applicator device may be mounted on a common frame, whereby the frame has a machine direction and a cross machine direction.

Hereby the rolls and the continuous strip are arranged in particular so that the longitudinal orientation of the continuous strip extends in the machine direction of the frame and the transverse orientation of the continuous strip extends in the cross machine direction of the frame. In addition, the position of the continuous strip relative to the cross machine direction of the frame may be measured during production of the pattern, whereby in a change in the position of the continuous strip, the position of the applicator device is changed accordingly in the cross machine direction of the frame or, respectively, in the transverse direction of the continuous strip.

The area to be printed is, for example, the circumferential area of the continuous strip.

The value and direction of the change in position of the applicator device, for example, corresponds with the value and direction to which the position of the continuous strip has changed in the cross machine direction of the frame or, respectively, in the transverse orientation of the continuous strip.

A first embodiment of the present invention provides that the position of the continuous strip is determined based on the position of one of its longitudinal edges. In order to determine the position of the continuous strip a photoelectric barrier may, for example, be used with which the position of one of the longitudinal edges of the continuous strip can be measured.

A first arrangement of the present invention provides that the applicator device includes a rotary screen which is movable parallel to the transverse orientation of the continuous strip and by means of which the pattern is applied onto the surface in a rotary screen printing process.

A second arrangement of the present invention provides that the applicator device includes one extrusion head which is movable at least parallel to the transverse orientation of the continuous strip and by means of which the pattern is applied onto the surface. During production of the pattern the extrusion head may additionally be moved parallel to the longitudinal direction of the continuous strip and/or perpendicular to the continuous strip.

A third arrangement of the present invention provides that the position of the continuous strip is measured prior to producing the pattern in order to determine an initial position for the applicator device.

If the applicator device is a rotary screen, then the rotary screen, when producing the pattern in a screen printing process rotating several times around its longitudinal axis, rolls on the circumferential surface of the continuous strip, whereby the pattern is applied onto the circumferential surface in at least one uninterrupted path running at least once uninterruptedly around the circumferential surface, so that the beginning and the end of each revolution of the path are arranged along a common straight line, whereby the rotary screen when rolling during each revolution of the path on the circumferential surface of the continuous strip performs N rotations around its longitudinal axis, and whereby N is a positive integer.

In other words, a continuous strip is provided with a circumferential surface which is to be printed. The continuous strip has a longitudinal orientation and a transverse orientation perpendicular thereto. The polymer material is applied in a screen printing process by means of a cylindrical rotary screen onto the circumferential surface of the continuous strip which is to be printed. In producing the pattern, the rotary screen—rotating several times around its longitudinal axis—rolls on the circumferential surface of the continuous strip whereby at least part of the pattern is applied onto the circumferential surface in at least one path running at least once uninterruptedly around the circumferential surface so that the beginning and the end of each revolution of the path are arranged along a common straight line. When rolling, the rotary screen performs N rotations around its longitudinal axis on the circumferential surface of the continuous strip during each revolution of the path, whereby N is a positive integer.

This arrangement of the present invention provides that the rotary screen performs one or several whole rotations around its longitudinal axis on the circumferential surface of the continuous strip during each revolution of the path. This provides that the rotary screen at the end of each revolution of the path is in the precise rotational position in which it was at the beginning of the revolution of the path. This ensures that the elements of the pattern at the beginning of the revolution of the path adjoin the pattern elements at the end of the revolution of the path without offset. This clearly allows an offset of the pattern elements forming the pattern to be further reduced.

The rotary screen may be in the embodiment of a cylindrical cylinder, such as a straight cylindrical cylinder and extends, for example, only over part of the width of the continuous strip. The length of the rotary screen can, for example, be between approximately 0.2 and 3 m, between 0.3 and 1 m; or approximately 0.5 m.

Depending upon how the rotary screen rolls on the circumferential surface of the continuous strip, various possibilities are conceivable as to how the beginning and the end of each revolution of the path can be arranged. A first possibility provides that the common straight line extends in the cross direction of the continuous strip. In this case, the beginning and the end of each revolution of the path are always arranged in the same position when viewed in the longitudinal direction of the continuous strip. This may be achieved, for example, if the longitudinal axis of the rotary screen during rolling of the rotary screen on the circumferential surface is aligned perpendicular to the longitudinal orientation of the continuous strip.

In this context, it is possible that the rotary screen rolls on the circumferential surface in an uninterrupted path, for example, over the entire width of the continuous strip, and that the rotary screen when rolling on the circumferential surface is displaced in the cross direction of the continuous strip in such a way that the adjacent path revolutions of the helix path complete each other to form the topographic pattern.

The helix path in this case is produced in that the rotary screen during production of the pattern and, while it rotates around its longitudinal axis which is aligned perpendicular to the longitudinal orientation of the continuous strip, is moved in the cross direction of the continuous strip. The movement in the cross direction of the continuous strip occurs here without a rotating component directed in the cross direction of the continuous strip.

Here, it is possible that the beginning and the end of each revolution of the path are arranged on a common straight line extending in the cross direction of the continuous strip, whereby the beginning and the end of each revolution of the path are offset relative to each other by the width of the path.

Alternatively, it is conceivable that the rotary screen is rolled on the circumferential surface of the continuous strip in several paths which are arranged adjacent to each other, whereby each path only makes one revolution on the circumferential surface which is to be printed, and the rotary screen is displaced in particular by the path width between application of two paths located adjacent to each other in the direction of the width of the continuous strip.

In this instance too, the rotary screen rotates around its longitudinal axis which is oriented perpendicular to the longitudinal orientation of the continuous strip, whereby in this case a movement in the cross direction only occurs when the rotary screen has produced a continuous path and must be brought into a position to produce an adjacent path.

A second possibility provides that the common straight line, together with the transverse orientation of the continuous strip, encompasses an angle greater than approximately 0° and less than approximately 90°. In this case, therefore, the beginnings and ends of all path revolutions are arranged on a common straight line extending diagonally to the cross direction of the continuous strip.

In this case too it is possible that the rotary screen rolls on the circumferential surface in an uninterrupted helix path, for example over the entire width of the continuous strip, and the rotary screen when rolling on the circumferential surface is displaced in the cross direction of the continuous strip in such a way that the adjacent path revolutions of the helix shaped path complete themselves to form the topographic pattern. This can, for example, be achieved in that the longitudinal axis of the rotary screen is oriented not parallel, but diagonal to the transverse orientation of the continuous strip when the rotary screen rolls on the circumferential surface. This means that while rolling on the circumferential surface, the rotary screen rotates around its longitudinal axis which is oriented diagonally to the transverse orientation of the continuous strip. In this case, the beginning and the end of each revolution of the path are arranged on a common straight line, whereby the beginning and the end of each path revolution are offset relative to each other by the width of the path. Here, the common straight line, together with the transverse orientation of the continuous strip encompasses an angle greater than approximately 0° and less than approximately 90°.

In the aforementioned arrangements, adjacent path revolutions may be arranged abutting each other, resulting in that the adjacent path revolutions complete themselves to form the topographic pattern.

A second embodiment of the present invention provides that the rotary screen has an outer shell surface which, when the rotary screen rolls on the circumferential surface, rotates with a circumferential speed and that the continuous strip travels around at least two rolls which are located at a distance from each other and parallel to each other with a transport speed directed parallel to its longitudinal orientation. Here, circumferential speed and transport speed are coordinated with each other so that the rotary screen makes N rotations around its longitudinal axis at each revolution of the path on the circumferential surface, and N is a positive integer.

The coordination between circumferential speed and transport speed occurs, for example, under consideration of the quotient of the length of one revolution of the path and the circumference of the outer shell surface of a circular cylindrical rotary screen.

If the rotary screen hereby produces the topographic pattern in a helix type path, one can for example distinguish between the two following scenarios:

a) The longitudinal axis of the rotary screen is positioned perpendicular to the longitudinal orientation of the continuous strip.

In this case—viewed in the longitudinal direction of the continuous strip—the beginning and the end of each path revolution are located at the same position. Further, the coordination between circumferential speed of the outer shell surface of the rotary screen and the transport speed of the continuous strip can occur under consideration of the quotient from the circumference of the continuous strip and the circumference of the outer shell surface of the circular cylindrical rotary screen.

b) The longitudinal axis of the rotary screen is not positioned perpendicular to the longitudinal orientation of the continuous strip.

In this case—viewed in the longitudinal direction of the continuous strip—the beginning and the end of each path revolution are located at different positions, depending on the position in which the rotary screen is located, viewed in the cross direction of the strip. Further, the coordination between circumferential speed and transport speed can occur by including the circumference of the continuous strip, the angle which is encompassed together by the longitudinal axis of the rotary screen and the longitudinal orientation of the continuous strip, and the circumference of the outer shell surface of the circular cylindrical rotary screen.

If the rotary screen produces the topographic pattern in several continuous paths which are located adjacent to each other, then the coordination between circumferential speed and transport speed occurs under inclusion of the circumference of the continuous strip and the circumference of the outer shell surface of the circular cylindrical rotary screen.

The coordination between circumferential speed and transport speed may be such that with a quotient resulting from the length of one path revolution and the circumference of the outer shell surface of the cylindrical rotary screen, which is different from a positive integer, the circumferential speed and the transport speed are different. In this case, a difference between circumferential speed and transport speed and a resulting relative movement at the moment of transfer of the polymer material from the rotary screen to the continuous strip provides that the rotary screen, when rolling during each revolution of the path, performs N rotations around its longitudinal axis on the circumferential surface of the continuous strip, whereby N is a positive integer.

Concretely this may mean that with a quotient with a number lower than 0.5 the circumferential speed is set lower than the transport speed. In addition this may mean that with a quotient with a number greater than 0.5 the circumferential speed is set to be higher than the transport speed.

The rotary screen is located, for example, at a location where the continuous strip is not carried around a roll. In addition a further embodiment of the present invention provides that the rotary screen, together with a mating roll, forms a nip through which the continuous strip is guided for application of the polymer material.

In order to ensure lateral adjoining of path revolutions arranged adjacent to each other in the cross direction of the continuous strip without offset of the pattern elements relative to each other, the rotary screen may have a perforation pattern establishing the topographic pattern and which, viewed in the longitudinal direction of the rotary screen, is limited by an end on one side and another end on the other side, whereby the one end on the one side of the perforation pattern represents the continuation of the other end side of the perforation pattern.

As already explained, the continuous strip can revolve at a transport speed around two rolls which are located at a distance from each other and which may be parallel to each other. It is further conceivable that the rolls are mounted together with the rotary screen in a machine frame, whereby the rotary screen and the rolls, viewed in the machine direction of the frame, are located stationary relative to each other. In addition, it is conceivable that the rotary screen when producing the pattern is moved relative to the rolls in the cross machine direction of the frame. When producing the pattern, the rotary screen may move continuously or incrementally in the cross machine direction of the frame.

Between the two rolls which are located at a distance from each other and around which the continuous strip travels, rollers may be arranged on which the continuous strip is supported on at least part of the travel distance between the two rolls.

The continuous strip supports itself on the rollers, for example, over the two travel distances, that is the upper and the lower travel distance between the rolls. In the upper travel distance the continuous strip hereby comes into contact with the rollers with its circumferential surface opposite to the circumferential surface which is to be printed. The continuous strip further comes into contact with the rollers in the lower travel distance with its printed circumferential surface.

Since the rolls respectively are mounted rotatably around their longitudinal axis, the topographic pattern is protected on the lower travel path.

Prior to the coordination between circumferential speed and transport speed, the circumference of the continuous strip may be measured.

A fourth arrangement of the present invention provides that the continuous strip—while traveling around the rolls—is subjected to a heat treatment. This heat treatment may, for example, serve to thermally and/or chemically activate the polymer material which was applied to the continuous strip.

In addition, a fifth arrangement of the present invention provides that the continuous strip—while traveling around the rolls—is subjected to tensile stress. The continuous strip is, for example, under tensile stress during the heat treatment, whereby the maximum tensile stress and maximum temperature during the heat treatment are less than the maximum tensile stress and maximum temperature during the prior thermo-setting of the continuous strip.

Typical values in this context are, for example, a maximum temperature during the heat treatment of approximately 160° C. at a maximum tensile stress of approximately 1 kN/m, as opposed to the thermo-setting where the maximum temperature is approximately 180° C. and the maximum tensile stress 1.5-2 kN/m. The aforementioned values may be parameters with a continuous strip in the form of, for example, a spiral link fabric.

According to a sixth arrangement, the continuous strip can be pulled during thermo-setting at a lower tensile stress than the maximum tensile stress after it has been pulled with the maximum tensile stress in its longitudinal direction. The lower tensile stress can be in the range of approximately 0.5-1.0 kN/m, for example with spiral link fabrics.

If, for example, a woven continuous strip is used, the maximum tensile can increase in heat treatment to approximately 7 kN/m. Consequently, a seventh arrangement of the present invention provides that the continuous strip is under a tensile stress in the range of approximately 0.5-7.0 kN/m during the heat treatment for curing of the applied polymer material.

In order to be able to maintain a constant width of the continuous strip while it travels around the rolls under tensile stress, a further development of the present invention provides that the continuous strip which is under tensile stress in its longitudinal orientation is held to a predetermined width or predetermined width range in its transverse orientation with the use of suitable means. Retention of the continuous strip in its transverse orientation may, for example, be used if the continuous strip is a woven fabric.

The polymer material may be applied onto the continuous strip in liquid or paste form by means of the rotary screen and subsequently subjected to a thermal and/or chemical activation treatment in order to cure it.

The polymer material is, for example, silicone or polyurethane.

During the application of the polymer material onto the continuous strip it may have a viscosity in the range of approximately 20000-80000 cps, for example in the range of approximately 50000-60000 cps.

During its travel around the two rolls the continuous strip may further be routed past a radiation source for its thermal and/or chemical activation. It must be mentioned in this context that liquid or paste silicone can be cured by heat treatment, for example by means of IR radiation. In addition, liquid or paste polyurethane can be cured, by for example, UV radiation.

The radiation source may be hereby directed, for example in the direction of the circumferential surface of the continuous strip which is to be printed, or respectively at least to be partially printed. In addition a flat sheet type opposing element may be provided which is arranged opposite the radiation source in such a way that the continuous strip travels through a space which is defined by the radiation source and the opposing element. Here, the circumferential surface facing away from the circumferential surface of the strip which is to be printed faces the opposing element. This means the continuous strip is guided between the radiation source and the flat opposing element. This method has proven itself in practical use, for example in the case of the continuous strip being in the form of a spiral link fabric. The opposing element may cause the heat emitted from the radiation source to be captured in the space and to be uniformly distributed and/or the radiation emitted from the radiation source to be reflected in the direction of the continuous strip. The opposing element may, for example, consist of a radiation reflecting, rather than radiation absorbing material. The flat opposing element may, for example, be a textile or non-textile sheet material. For example, a woven fabric may be used as textile sheet material. A non-textile sheet material could, for example, be a foil or sheet metal.

In order to achieve uniform longitudinal expansion over the width of the continuous strip the continuous strip may be subjected uniformly across its entire width to the radiation. This may be useful if the continuous strip is heated by the radiation.

In order to obtain precise information regarding the circumference of the continuous strip, the continuous strip may be subjected to a heat treatment prior to measuring its circumference, whereby the circumference of the continuous strip is measured after the circumference has adjusted to a constant value. The circumference may be measured before the topographic pattern is applied to the continuous strip. This may be done, for example, if the continuous strip is subjected to a heat treatment in order to cure the polymer material.

The circumference of the continuous strip is typically greater than approximately 10 meters, for example greater than approximately 30 meters. Further, the circumference of the outer shell surface of the cylindrical rotary screen is typically less than approximately 1 meter.

The continuous strip may be a woven fabric or a spiral link fabric. The continuous strip may be produced from at least one of the following materials: PET, PPS, PCT, PCTA.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a side view of a device to implement the method according to the present invention;

FIG. 2 is a top view of the device shown in FIG. 1;

FIG. 3 is a first embodiment of the method according to the present invention;

FIG. 4 is a second embodiment of the method according to the present invention;

FIG. 5 is a third embodiment of the method according to the present invention; and

FIG. 6 is a schematic drawing of the inventive principle.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

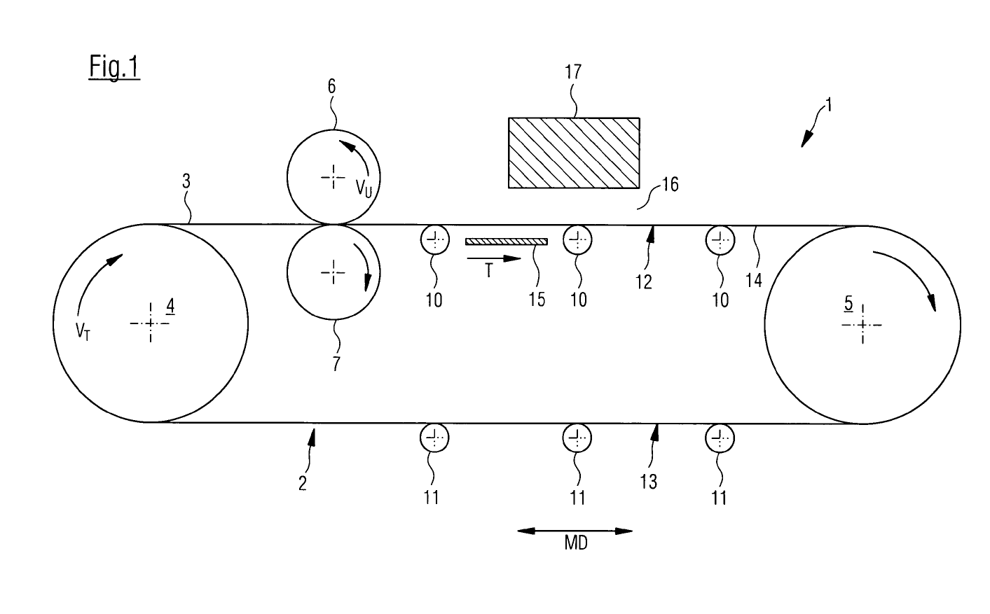

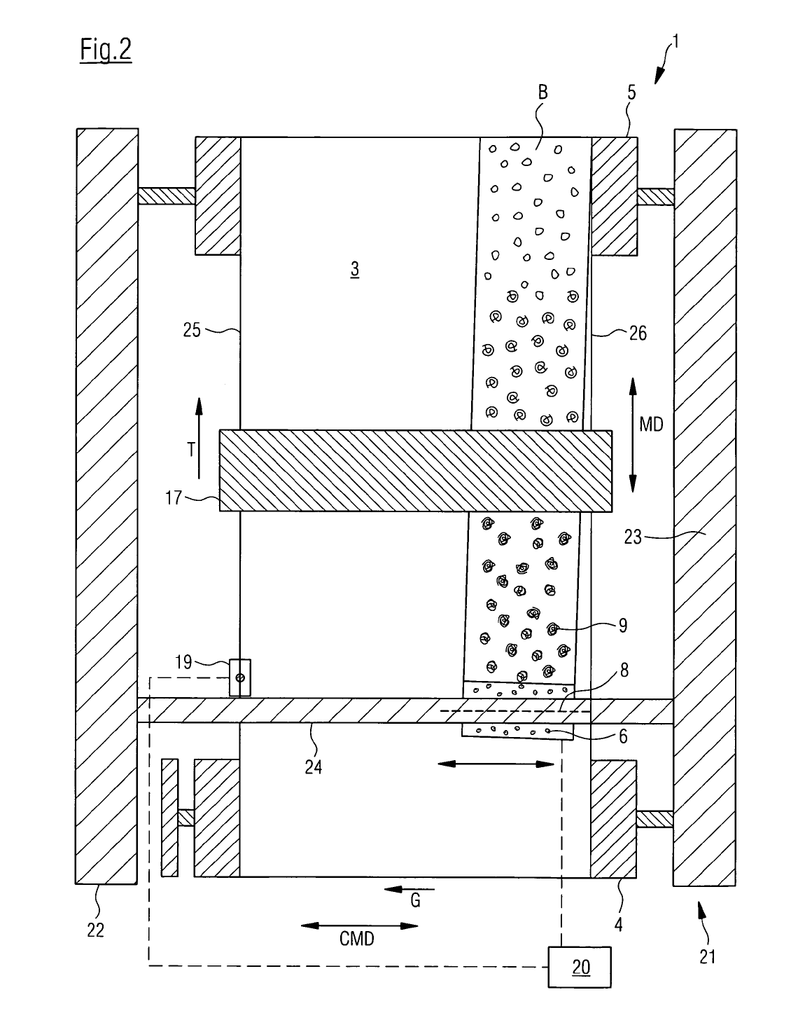

Referring now to the drawings, and more particularly to FIG. 1, there is shown a side view of device 1 to implement the method according to the present invention. Referring now to FIG. 2, there is shown a top view of the device illustrated in FIG. 1. Continuous strip 2 in the embodiment of a spiral link fabric having circumferential surface 3 which is to be printed is guided around rolls 4, 5 which are located at a distance from each other and parallel to each other. The continuous strip has longitudinal direction MD and cross direction CMD perpendicular thereto.

Device 1 includes applicator device 6 which, in the current example, is in the embodiment of rotary screen 6. Rolls 4, 5 and rotary screen 6 are mounted in frame 21 which has machine direction MD and cross machine direction CMD, whereby machine direction MD of frame 21 extends parallel to the longitudinal direction of continuous strip 2, and cross machine direction CMD of frame 21 extends parallel to the cross direction of the continuous strip. In addition, rolls 4, 5 are arranged parallel to cross direction CMD of frame 21.

Frame 21 includes a left frame component 22 and right frame component 23 on which the axial ends of rolls 4, 5 are mounted. Frame 21 further includes tie bar 24 in cross machine direction CMD of the frame which connects left frame component 22 with right frame component 23 and on which applicator device 6, which is movable in CMD direction, is mounted. For purposes of clarity the frame is not illustrated in FIGS. 1 and 3-5.

Cylindrical rotary screen 6 is mounted rotatably on longitudinal axis 8. In the rotary screen printing process polymer material 9 can be applied with rotary screen 6 onto circumferential surface 3 of continuous strip 2 which is to be printed, thereby forming a topographic pattern on circumferential surface 3. During the application, polymer material 9 is in a liquid or paste state and can have a viscosity in the range of approximately 20000-80000 cps, for example in the range of approximately 50000-60000 cps.

A mating roll 7 is provided in addition to rotary screen 6 which, together with rotary screen 6, forms a nip through which continuous strip is guided for application of polymer material 9. In the current example rotary screen 6 is arranged in a location where continuous strip 2 is not routed around one of rolls 4, 5. Between rolls 4, 5, which are located at a distance from each other and around which continuous strip 2 travels, device 1 is equipped with rollers 10, 11 on which continuous strip 2 is supported between rolls 4, 5 over both travel distances, that is on upper travel path 12 and on lower travel path 13.

In upper travel path 12 continuous strip 2 hereby comes into contact with roller 10 with its circumferential surface 14 which is opposite circumferential surface 3 which is to be printed. Furthermore, in lower travel path 13 continuous strip 2 comes into contact with roller 11 with its at least partially printed circumference surface 3. Rollers 10, 11 rotate around their longitudinal axis.

Continuous strip 2 is subjected to a heat treatment while traveling around rolls 4, 5. This heat treatment thermally activates polymer material 9—in this example silicone—which is applied to continuous strip 2, causing it to cure. For the purpose of heat treatment, continuous strip 2 during its travel around rolls 4, 5 is routed past radiation source 17 which, in the current example, produces IR radiation and emits the radiation in the direction of circumference surface 3. In addition flat opposing element 15 is provided which is arranged opposite radiation source 17 in such a way that continuous strip 2 travels through space 16 which is defined by radiation source 17 and opposing element 15. Here, circumferential surface 14 facing away from circumferential surface 3 of strip 2 which is to be printed faces opposing element 15 which is in the form of a white screen. This means continuous strip 2 is guided between radiation source 17 and screen 15.

In the current example opposing element 15 causes the heat emitted from radiation source 17 to be captured in space 16 and to be uniformly distributed and/or the radiation emitted from radiation source 17 to be reflected in the direction of continuous strip 2.

In order to achieve uniform longitudinal expansion over the width of continuous strip 2 continuous strip 2, may be subjected uniformly across its entire width to the radiation. This is possible if, for example, the continuous strip is heated by the radiation.

In order to produce the pattern, applicator device 2 is moved in relation to strip 2 in basic movement G which is parallel to cross direction CMD of strip 2. In addition during production of the pattern, circumferential surface 3 of continuous strip 2 which is to be printed moves relative to applicator device 6 with transport movement T directed parallel to longitudinal direction MD of continuous strip 2.

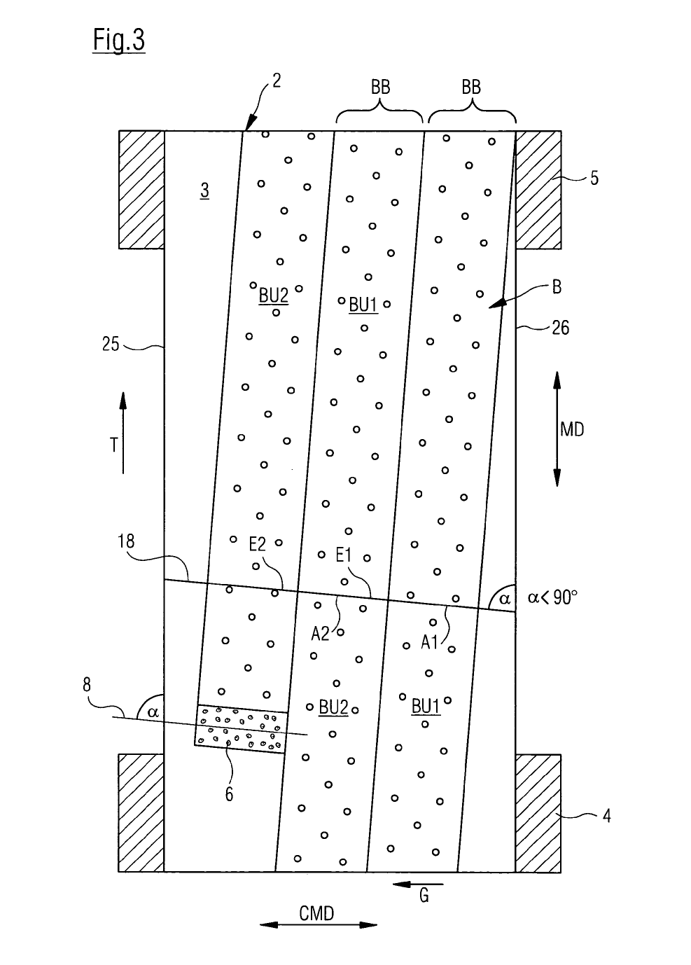

In the current example applicator, device 6 includes rotary screen 6. Rotary screen 6, when producing the pattern, rotating several times around longitudinal axis 8 rolls on circumferential surface 3 of continuous strip 2, whereby at least a part of the pattern is applied onto circumferential surface 3 in at least one path B running at least once uninterruptedly around the circumferential side, so that beginning A and end E of each path revolution BU is arranged along common straight line 18 (see FIGS. 3-5).

Hereby rotary screen 6 is moved either continuously or incrementally in cross direction CMD of the continuous strip.

Device 1 also includes photoelectric barrier 19 by means of which the position of continuous strip 2, relative to a stationary reference position, is measured in one direction parallel to cross direction CMD of continuous strip 2 during production of the pattern. The reference position may, for example, be determined by a position in cross machine direction CMD of frame 21. Photoelectric barrier 19, as well as the range of mobility with which rotary screen 6 can be moved in cross machine direction CMD of frame 21, or respectively in cross direction of continuous strip 2, are tied into control system 20. Control system 20 permits that during the production of the pattern:

i) The position of continuous strip 2 parallel to its transverse orientation CMD, for example relative to a stationary reference position, is measured; and

ii) The position of application device 2 is changed by a corrective movement parallel to transverse orientation CMD of continuous strip 2 when the position of continuous strip 2 parallel to its transverse orientation CMD is changed, the corrective movement being superimposed on basic movement G.

In the current example, the value and direction of the change in position of rotary screen 6 in CMD corresponds with the value and direction to which the position of continuous strip 2 has changed in cross machine direction CMD of continuous strip 2.

As can be seen in the illustration in FIG. 2, the position of continuous strip 2 in the current example is determined through the position of one of longitudinal edges 25.

In the illustrations in FIGS. 2-5 circumferential surface 3 of continuous strip 2 is only covered partially with the pattern. The areas with the pattern are dotted, whereby the dots represent the pattern.

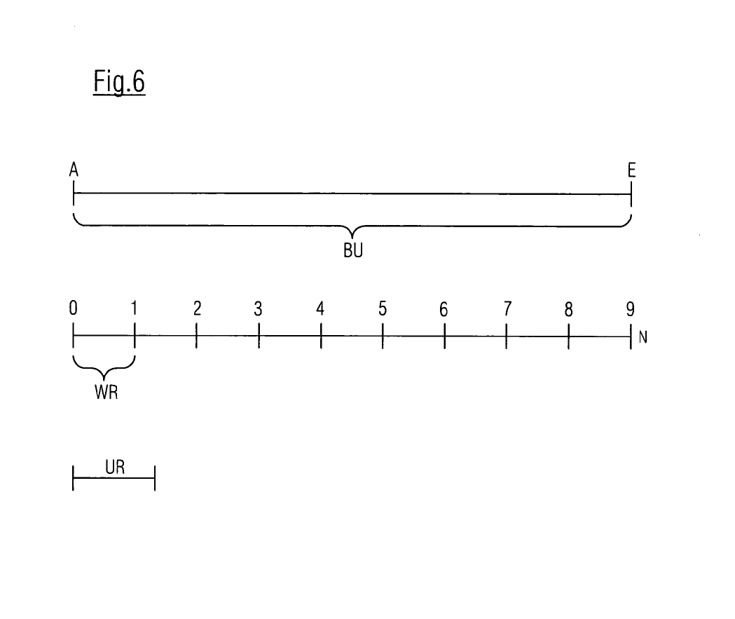

Referring now to FIG. 6, there is schematically shown a possible further development of the method of the present invention. On the upper straight line path revolution BU is shown which extends from beginning A to end E. The center straight line illustrates travel path WR over which the rotary screen travels if it makes a turn during rolling on the circumferential surface of the continuous strip. The center straight line also shows number N of revolutions which rotary screen 6 performs during rolling on circumferential surface 3 of continuous strip 2 during path revolution BU.

Rotary screen 6 is hereby rolled on circumferential surface 3 in a way that it performs N revolutions around longitudinal axis 8 during each revolution of path PU on circumferential surface 3 of the continuous strip, whereby N is a positive integer.

This particular arrangement provides that rotary screen 6 performs one or more complete rotations around longitudinal axis 8 on circumferential surface 3 of continuous strip 2 during each path revolution BU. This achieves that rotary screen 6 at end E of each revolution of path BU is in the precise rotational position in which it was at beginning A of the revolution of path BU. This ensures that the elements of the pattern at beginning A of the revolution of path BU adjoin the pattern elements at end E of the revolution of path BU without offset.

In the example illustrated in FIG. 6, rotary screen 6 performs nine rotations around longitudinal axis 8 during one revolution of path BU. In other words this means that the rotary screen travels along travel distance WR during each rotation around its longitudinal axis, so that one revolution of path BU is an integer multiple of travel distance WR of each Rotation which the rotary screen performs on rolling on the circumferential surface. This means BU=N×WR, whereby N is a positive integer.

The bottom straight line in FIG. 6 indicates the circumference of the outer shell surface of the rotary screen. As can be seen, circumference UR is greater than travel distance WR which has to be traveled by the rotary screen during one rotation of the rotary screen, so that the rotary screen rotates around its longitudinal axis one complete time during one revolution of path BU. In order to achieve this, the following steps may be taken: The outer shell surface of rotary screen 6, rotates with circumferential speed Vu when rotary screen 6 rolls on circumferential surface 3 of continuous strip 2. Continuous strip 2 further runs around rolls 4, 5 which are located at a distance from each other and parallel to each other with transport speed Vt oriented parallel to longitudinal direction MD. Here, circumferential speed Vu and transport speed Vt are coordinated with each other so that rotary screen 6 performs N rotations around longitudinal axis 8 at each revolution of path BU on circumferential surface 3, and N is a positive integer.

The coordination between circumferential speed Vu and transport speed Vt occurs for example under consideration of the quotient of the length of one revolution of path BU and circumference UR of the outer shell surface of circular cylindrical rotary screen 6.

If, for example, revolution of path BU is identical to the circumference of the continuous strip, the coordination between circumferential speed Vu and transport speed Vt occurs under consideration of the quotient of the circumference of continuous strip 2 and circumference UR of the outer shell surface of circular cylindrical rotary screen 6.

It must be pointed out that a revolution of path BU may extend parallel to longitudinal direction MD of continuous strip 2, or diagonally to same, depending upon the utilized method.

Referring now to FIG. 3, there is shown a first embodiment of the method of the present invention. Here, rotary screen 6 rolls on circumferential surface 3 in an uninterrupted helix type path B. Path B is formed by a plurality of adjoining path revolutions, whereby in this example, revolutions of paths BU1 and BU2 are indicated. Each revolution of path BU1, BU2 is limited in its length by beginning A and end E. Revolution of path BU1, for example, is limited in its length by beginning A1 and end E1. As can be seen in the illustration in FIG. 3, ends E1, E2 and beginnings A1, A2 of all revolutions of paths BU1, BU2 are located on common straight line 18 which, together with longitudinal direction MD of continuous strip 2 encompasses angle α≠90°. In this case, beginning A1, A2 and end E1, E2 of all revolutions of paths BU1, BU2 are arranged on common straight line 18 extending diagonally to the longitudinal and transverse orientation of continuous strip 2. Beginning A1, A2 and end E1, E2 of each path revolution BU1, BU2 is herewith always offset relative to each other by width BB of path B.

When rotary screen 6 rolls on circumferential surface 3 it is displaced in cross direction CMD of continuous strip 2 in such a way that the adjacent revolutions of paths BU1, BU2 of helix path B complete each other to form the topographic pattern. For this purpose, adjacent path revolutions BU1, BU2 abut each other.

To produce an uninterrupted helix type path, rotary screen 6, when rolling on circumferential surface 3, is displaced in cross direction CMD of continuous strip 2 in such a way that the adjacent path revolutions of the helix path complete each other to form the topographic pattern. This means that basic movement G and transport movement T complement each other such that rotary screen 6 rolls on circumferential surface 3 of continuous strip 2 in an uninterrupted helix type path, thereby applying the pattern in the form of a helix type path on circumferential surface 3 of continuous strip 2.

In order to produce a helix type path, rotary screen 6 moves at basic motion G continuously parallel to cross direction CMD of continuous strip 2.

In the current example, longitudinal axis 8 of rotary screen 6 is not parallel during rolling of rotary screen 6 on circumferential surface 3, but is arranged diagonally to cross direction CMD of continuous strip 2. In the current example, longitudinal axis 8 of rotary screen 6, together with longitudinal direction MD of continuous strip 2 encompasses angle α. This means that rotary screen 6 when rolling on circumferential surface 3 revolves around its longitudinal axis which is oriented diagonally to the longitudinal and the cross direction of continuous strip 2.

In the example illustrated in FIG. 3, beginning and end of each revolution of path BU viewed in longitudinal direction MD of the continuous strip are located in different positions. This means that—viewed in longitudinal direction MD of the continuous strip—at each revolution of continuous strip 2 around rolls 4, 5 the position of beginning A and end E of the revolution of path BU changes depending upon the location of rotary screen 6, viewed in cross direction CMD of continuous strip 2.

In the embodiment illustrated in FIG. 3 coordination between circumferential speed Vu and transport speed Vt occurs under consideration of the circumference of continuous strip 2, angle α which is encompassed by longitudinal axis 8 of rotary screen 6 and longitudinal direction MD of continuous strip 2 together, and of the circumference of the outer shell surface of cylindrical rotary screen 6.

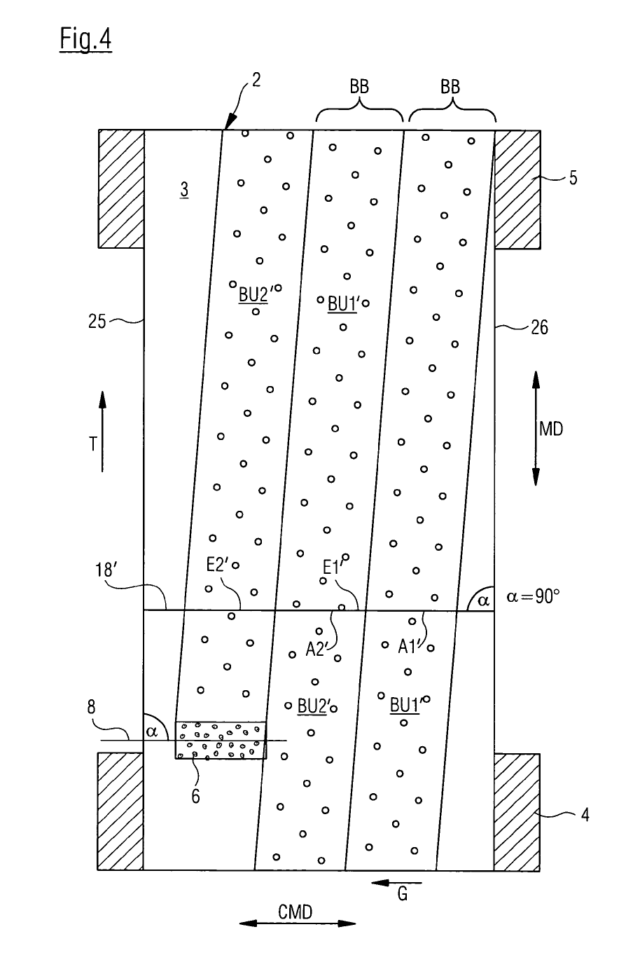

Referring now to FIG. 4, there is shown a second embodiment of the method of the present invention. Here, rotary screen 6 rolls on circumferential surface 3 in uninterrupted helix-type path B.

In this case too, basic movement G and transport movement T complement each other such that rotary screen 6 rolls on circumferential surface 3 of continuous strip 2 in an uninterrupted helix type path. Furthermore, also in this case, rotary screen 6 moves at basic movement G continuously parallel to cross direction CMD of continuous strip 2.

Path B is formed by a plurality of adjoining revolutions of paths BU, whereby in this example revolutions of paths BU1′ and BU2′ are indicated. Each revolution of path BU1′, BU2′ is limited in its length by beginning A and end E. Revolution of path BU1′, for example, is limited in its length by beginning A1′ and end E1′. As can be seen in the illustration in FIG. 4, ends E1′, E2′ and beginnings A1′, A2′ of all revolutions of paths are located on common straight line 18′ which, together with longitudinal direction MD of continuous strip 2 encompasses angle α=90°. In this case, beginning A1′, A2′ and end E1′, E2′ of all revolutions of paths BU1′, BU2′ are arranged on common straight line 18′ extending parallel to cross direction CMD of continuous strip 2. Beginning A1′, A2′ and end E1', E2′ of each revolution of path BU1′, BU2′ is herewith always offset relative to each other by width BB of path B, viewed in cross direction CMD of the continuous strip. This means that beginning A1′ of the revolution of path BU1′, viewed in cross direction CMD of continuous strip 2 is offset by path width BB to end E1″ of revolution of path BU1″.

When rotary screen 6 rolls on circumferential surface 3 it is displaced in cross direction CMD of continuous strip 2 in such a way that adjacent paths BU1′, BU2′ of helix path B complete each other to form the topographic pattern. For this purpose adjacent revolutions of paths BU1′, BU2′ abut each other.

In the current example, longitudinal axis 8 of rotary screen 6 is oriented parallel to cross direction CMD of continuous strip 2 during rolling of rotary screen 6 on circumferential surface 3. In the current example therefore, longitudinal axis 8 of rotary screen 6, together with longitudinal direction MD of continuous strip 2 encompasses angle α=90°. This means that rotary screen 6 when rolling on circumferential surface 3 revolves around longitudinal axis 8 which is oriented parallel to cross direction CMD of continuous strip 2.

In the example illustrated in FIG. 4, beginning and end of each revolution of path BU viewed in longitudinal direction MD of the continuous strip are located always in the same position. This means that—viewed in cross direction CMD of the continuous strip—at each revolution of continuous strip 2 around rolls 4, 5 a revolution of path BU is also performed, independent of the position of the rotary screen 6.

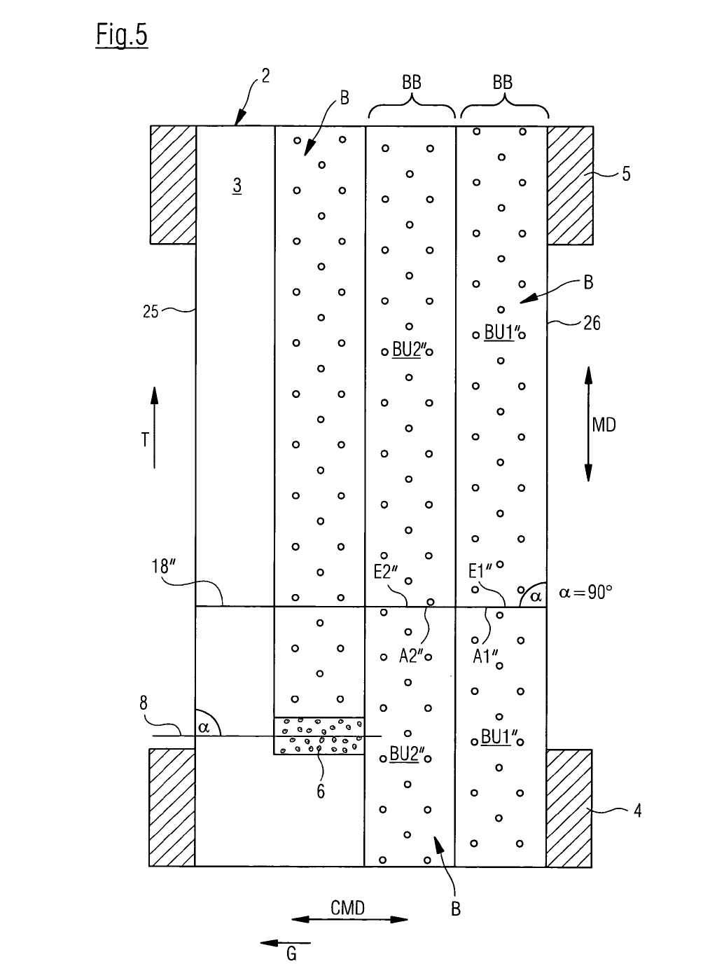

In the embodiment of the present invention illustrated in FIG. 5, rotary screen 6 rolls in several adjacent paths B on circumferential surface 3 of continuous strip 2, whereby each path B performs only one revolution of path BU on circumferential surface 3 which is to be printed. This means each revolution of path BU produces one path B. In addition, rotary screen 6 is displaced in the cross direction of continuous strip 2, by path width BB between application of two adjacent paths BU1″, BU2″, BU3″. This means that basic movement G and transport movement T complement each other such that rotary screen 6 rolls on circumferential surface 3 of continuous strip 2 in several adjacently located paths B, whereby in the current example after each completed revolution of path BU, rotary screen 6 moves at basic movement G incrementally parallel to cross direction CMD of continuous strip 2. In the current example, basic movement G consists of several discrete movement steps.

In the embodiment of the present invention illustrated in FIG. 5, beginning A1″, A2″ and end E1″, E2″ of each revolution of path BU1″, BU2″ are not offset relative to each other, viewed in cross direction CMD of continuous strip 2.

As can be seen from the illustration in FIG. 5, ends E1″, E2″ and beginnings A1″, A2″ of all revolutions of the paths are located on common straight line 18″ which, together with longitudinal direction MD of continuous strip 2 encompasses angle α=90°. In this case therefore, beginning A1″, A2″ and end E1″, E2″ of all revolutions of paths BU1″, BU2″ are arranged on common straight line 18″ extending parallel to cross direction CMD of continuous strip 2.

Between production of sequential revolutions of paths BU1″, BU2″ rotary screen 6 is displaced on circumferential surface 3 in cross direction CMD of continuous strip 2 in such a way that the adjacent revolutions of paths BU1″, BU2″ complete each other to form the topographic pattern. Adjacent revolutions of path BU1″, BU2″ hereby abut each other. When producing the revolutions of paths BU1″, BU2″ rotary screen 6 is not offset in cross direction CMD of continuous strip 2. A movement of rotary screen 6 in cross direction CMD occurs only when rotary screen 6 has produced continuous path BU1″, BU2 and must be brought into a position to produce an adjacent path.

In the current example longitudinal axis 8 of rotary screen 6 is oriented parallel to cross direction CMD of continuous strip 2 when rotary screen 6 rolls on circumferential surface 3. Consequently, in the current example, longitudinal axis 8 of rotary screen 6 together with longitudinal direction MD of continuous strip 2 encompasses angle α=90°. This means that when rolling on circumferential surface 3 rotary screen 6 rotates around longitudinal axis 8 which is oriented parallel to cross direction CMD of continuous strip 2.

In the example illustrated in FIG. 5, beginning and end of each revolution of path BU—viewed in longitudinal direction MD of the continuous strip—are always located in the same position. This means that with each revolution of continuous strip 2 around rolls 4, 5 a revolution of path BU is also completed, independent of the location of rotary screen 6, viewed in cross direction CMD of continuous strip 2.

In the embodiments of the present invention illustrated in FIGS. 4 and 5, the coordination between circumferential speed Vu and the outer shell surface of rotary screen 6, and transport speed Vt of continuous strip 2 occurs under consideration of the quotient from the circumference of continuous strip 2 and the circumference of the outer shell surface of cylindrical rotary screen 6.

In all of the examples illustrated in FIGS. 2-5 basic movement G progresses from right longitudinal edge 26 to left longitudinal edge 25 of the continuous strip.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for producing a polymer topographic pattern on a continuous strip having a longitudinal orientation and a transverse orientation perpendicular to the longitudinal orientation, the method comprising the steps of:
moving an applicator device in relation to said continuous strip in a basic movement parallel to said transverse orientation of said continuous strip;
applying said pattern to an area of said continuous strip to be imprinted with said applicator device;
measuring a position of said continuous strip parallel to said transverse orientation;
changing a position of said applicator device by a corrective movement parallel to said transverse orientation of said continuous strip when said position of said continuous strip parallel to said transverse orientation is changed, said corrective movement being superimposed to said basic movement.

2. The method according to claim 1, wherein said measurement of said position of said continuous strip is relative to a stationary reference position.

3. The method according to claim 2, wherein during said basic movement, said applicator device moves at least one of continuously and incrementally parallel to said transverse orientation of said continuous strip.

4. The method according to claim 3, wherein during the production of said pattern, said area of said continuous strip to be imprinted moves in a transport direction parallel to said longitudinal orientation of said continuous strip relative to said applicator device.

5. The method according to claim 4, wherein during said transport movement said continuous strip travels around at least two rolls located at a distance from each other and positioned parallel to each other.

6. The method according to claim 5, wherein a value and a direction of said corrective movement corresponds to another value and another direction of said changed position of said continuous strip parallel to said transverse orientation.

7. The method according to claim 6, wherein said position of said continuous strip is determined based on a position of a longitudinal edge of said continuous strip.

8. The method according to claim 7, wherein said position of said longitudinal edge parallel to said transverse orientation of said continuous strip is determined by a photoelectric barrier through which said longitudinal edge is guided.

9. The method according to claim 8, wherein said applicator device includes a rotary screen movable parallel to said transverse orientation of said continuous strip, said rotary screen applying said pattern onto a surface of said continuous strip in a rotary screen printing process.

10. The method according to claim 8, wherein said applicator device includes an extrusion head movable at least parallel to said transverse orientation of said continuous strip, said pattern being applied onto a surface of said continuous strip with said extrusion head.

11. The method according to claim 10, wherein during the production of said pattern said extrusion head is moved at least one of parallel to said transverse orientation, parallel to said longitudinal orientation and perpendicular to said continuous strip.

12. The method according to claim 11, wherein said position of said continuous strip is measured a plurality of times in a chronological sequence during the production of said pattern.

13. The method according to claim 12, wherein said position of said continuous strip is measured at least every 5 to 50 ms.

14. The method according to claim 13, wherein said position of said continuous strip is measured at least every 10 to 30 ms.

15. The method according to claim 14, wherein said position of said continuous strip is measured prior to the producing of said pattern to determine an initial position for said applicator device.

16. The method according to claim 15, wherein a response time between measurement of a change in position of said continuous strip and said corrective movement is less than approximately 100 ms.

17. The method according to claim 16, wherein said response time is less than 50 ms.

18. The method according to claim 14, wherein a polymer material is applied onto said surface of said continuous strip in a screen printing process with a cylindrical rotary screen having a longitudinal axis, said cylindrical rotary screen rotating a plurality of times around said longitudinal axis and rolling on a circumferential surface of said continuous strip, said pattern being applied onto said circumferential surface in at least one path running at least uninterruptedly around said circumferential surface such that a beginning and an end of each revolution of said path are arranged along a common straight line, said rotary screen when rolling performing N rotations around said longitudinal axis on said circumferential surface of said continuous strip during each of said revolutions of said path and wherein N is a positive integer.

19. The method according to claim 18, wherein said common straight line extends in a cross direction of said continuous strip.

20. The method according to claim 19, wherein said common straight line together with said transverse orientation of said continuous strip encompasses an angle greater than approximately 0° and less than approximately 90°.

21. The method according to claim 20, wherein said rotary screen extends only over a part of a width of said continuous strip.

22. The method according to claim 21, wherein said longitudinal axis of said rotary screen during said rolling of said rotary screen on said circumferential surface is aligned perpendicular to said longitudinal orientation of said continuous strip.

23. The method according to claim 22, wherein said rotary screen rolls on said circumferential surface in an uninterrupted helix-shaped path and said rotary screen when rolling on said circumferential surface is displaced in said cross direction of said continuous strip such that a plurality of revolutions of said helix-shaped path complete themselves to form said topographic pattern.

24. The method according to claim 23, wherein said rotary screen rolls on said circumferential surface in said uninterrupted helix-shaped path over an entire width of said continuous strip.

25. The method according to claim 24, wherein said rotary screen is rolled on said circumferential surface of said continuous strip in a plurality of paths arranged adjacent to each other, each of said plurality of paths completing only one complete revolution on said circumferential surface and said rotary screen being displaced by a path width between an application of two of said plurality of paths located adjacent to each other in a direction of a width of said continuous strip.

26. The method according to claim 25, wherein when said rotary screen rolls on said circumferential surface, said longitudinal axis of said rotary screen is positioned relative to said transverse orientation of said continuous strip at an angle greater than approximately 0°.

27. The method according to claim 26, wherein said rotary screen has an outer shell surface rotating with a circumferential speed when said rotary screen rolls on said circumferential surface and said continuous strip travels around at least two rolls located at a distance from each other and parallel to each other with a transport speed directed parallel to said longitudinal orientation, said circumferential speed and said transport speed being coordinated with each other such that said rotary screen makes N rotations around said longitudinal axis at each said revolution of said helix-shaped path on said circumferential surface and wherein N is a positive integer.

28. The method according to claim 27, wherein said coordination between said circumferential speed and said transport speed occurs under consideration of a quotient of a length of one of said revolutions of said helix-shaped path and said circumference of said outer shell surface of said cylindrical rotary screen.

29. The method according to claim 28, said coordination between said circumferential speed and said transport speed is such that with a quotient resulting from said length of said one revolution of said path and said circumference of said outer shell surface of said cylindrical rotary screen, wherein said quotient is different from a positive integer and said circumferential speed and said transport speed are different.

30. The method according to claim 29, wherein said rotary screen is located in a position in which said continuous strip is not routed around a roll.

31. The method according to claim 31, said rotary screen has a perforation pattern establishing said topographic pattern, said perforation pattern limited by an end on one side and another end on another side of said perforation pattern when viewed in a longitudinal direction of said rotary screen, wherein said one end side of said perforation pattern represents a continuation of said other end side of said perforation pattern.

32. The method according to claim 31, wherein prior to said coordination between said circumferential speed and said transport speed a circumference of said continuous strip is measured.

33. The method according to claim 32, wherein said continuous strip is subjected to a heat treatment when traveling around said rolls.

34. The method according to claim 33, wherein said continuous strip is subjected to tensile stress when traveling around said rolls.

35. The method according to claim 34, wherein said polymer material is applied onto said continuous strip in one of a liquid form and a paste form with said rotary screen and said polymer material is subsequently subjected to at least one of a thermal and a chemical activation treatment to cure said polymer material.

36. The method according to claim 35, wherein said continuous strip is subjected to said heat treatment prior to said measuring of said circumference of said continuous strip and said circumference of said continuous strip is measured after said circumference has adjusted to a constant value.

37. The method according to claim 36, wherein said circumference is measured before said topographic pattern is applied onto said continuous strip.

38. The method according to claim 37, wherein said continuous strip is one of a woven fabric and a spiral link fabric.
